(19) United States
(12) Patent Application Publication
(10) Pub. No.: US 2026/0153908 A1
(43) Pub. Date: Jun. 4, 2026

(54) Dual-Axis Drive Assembly for Use with a Reconfigurable Electronic Device

(71) Applicant: Zepp, Inc., Milpitas, CA (US)

(72) Inventors: Mingbao Shao, Shenzhen (CN); Aijun Zou, Shenzhen (CN); Bo Zeng, Hefei (CN); Kaile Bai, Shenzhen (CN)

(21) Appl. No.: 19/007,063

(22) Filed: Dec. 31, 2024

(30) Foreign Application Priority Data
Dec. 3, 2024 (CN) 202411764076.1
Dec. 3, 2024 (CN) 202422972561.X

(51) Int. Cl. G06F 1/16

(52) U.S. Cl. CPC G06F 1/1681

(57) ABSTRACT

A reconfigurable (e.g., foldable) electronic device that includes a housing and a drive assembly, which is connected to the housing and is configured to facilitate reconfiguration of the electronic device between folded and unfolded configurations. The drive assembly includes, among other components: an electric motor assembly; a transmission with first and second transmission assemblies; and a synchronizing rod, which extends between and operatively, e.g., indirectly, connects the transmission assemblies to facilitate power transfer therebetween. The transmission assemblies are operatively, e.g., indirectly, connected to the housing such that torque is applied to the housing via the transmission assemblies to thereby reconfigure (e.g., fold) the electronic device.

### CROSS-REFERENCE TO RELATED APPLICATION(S)

This application claims the benefit of and priority to Chinese Application No. 202411764076.1, filed on Dec. 3, 2024, and Chinese Application No. 202422972561.X, filed on Dec. 3, 2024, the entire contents of which are hereby incorporated by reference.

### TECHNICAL FIELD

The present disclosure relates to a reconfigurable (e.g., foldable) electronic device that includes a dual-axis drive assembly.

### BACKGROUND

Reconfigurable electronic devices are becoming increasingly popular, particularly in the context of mobile phones, watches, tablets, smart devices, etc. Known devices, however, are either manually folded and unfolded, which is cumbersome and relies upon the user's strength and dexterity, or incorporate a single-shaft drive assembly.

The present disclosure addresses these shortcomings by providing a reconfigurable electronic device that includes a dual-axis drive assembly.

### SUMMARY

In one aspect of the present disclosure, an electronic device is disclosed that includes: a housing, which is reconfigurable between unfolded and folded configurations about a folding axis, and a drive assembly, which is connected to the housing and is configured to facilitate reconfiguration of the housing between the unfolded and folded configurations.

The drive assembly includes a transmission, which is connected to the housing, and at least one motor assembly, which is connected to the transmission such that power from the at least one motor assembly is delivered to the housing via the transmission.

The transmission includes a first transmission assembly, which includes a first plurality of gears, and a second transmission assembly, which includes a second plurality of gears.

The drive assembly defines a first axis of rotation and a second axis of rotation that each extend between the first transmission assembly and the second transmission assembly.

In certain embodiments, the first transmission assembly may be connected to the second transmission assembly.

In certain embodiments, the second transmission assembly may be spaced from the first transmission assembly along the folding axis.

In certain embodiments, the electronic device may further include one or more anchors that extend between and connect the housing and the transmission.

In certain embodiments, the one or more anchors may include a first anchor, which engages the first transmission assembly and spans the folding axis, and second anchor, which engages the second transmission assembly and spans the folding axis.

In certain embodiments, the housing may include a first housing portion that is movable about the first axis of rotation, and a second housing portion that is movable in relation to the first housing portion about the second axis of rotation.

In certain embodiments, the first transmission assembly and the second transmission assembly may each include a first end that is connected to the first housing portion, and a second end that is connected to the second housing portion.

In certain embodiments, the first end of the first transmission assembly may be spaced from the second end of the first transmission assembly along a first axis, and the first end of the second transmission assembly may be spaced from the second end of the second transmission assembly along a second axis that extends in generally parallel relation to the first axis.

In certain embodiments, the first axis and the second axis may each be oriented in generally orthogonal relation to the folding axis.

In certain embodiments, the first axis of rotation and the second axis of rotation may extend between the first transmission assembly and the second transmission assembly.

In certain embodiments, the drive assembly may be configured such that the first axis of rotation and the second axis of rotation are offset along a length of the electronic device.

In certain embodiments, the drive assembly may be configured such that the first axis of rotation and the second axis of rotation are generally aligned along a length of the electronic device.

In certain embodiments, the at least one motor assembly may include: at least one motor; at least one gear box that is connected to the at least one motor; and at least one drive shaft that is connected to the at least one gear box and which engages the transmission.

In certain embodiments, the electronic device may further include a synchronizing rod that connects the first transmission assembly and the second transmission assembly.

In certain embodiments, the synchronizing rod may extend in generally parallel relation to the at least one drive shaft.

In certain embodiments, the at least one motor assembly may include a first motor assembly and a second motor assembly.

In certain embodiments, the first motor assembly and the second motor assembly may be offset along a length of the electronic device.

In certain embodiments, the first motor assembly and the second motor assembly may be generally aligned along a length of the electronic device.

In another aspect of the present disclosure, an electronic device is disclosed that includes a housing; one or more anchors that are connected to the housing and which include one or more arcuate struts; a support assembly that is connected to the one or more anchors; a transmission that engages the one or more anchors; and a motor assembly that is connected to the transmission, wherein the transmission is configured to transmit power from the motor assembly to the one or more anchors to thereby reconfigure the electronic device between unfolded and folded configurations.

The support assembly includes a bracket, which defines an arcuate groove, and one or more arms, which engage the bracket and include a first end and second end. The first end includes an arcuate rib that is positioned within the arcuate groove such that the one or more arms are repositionable in relation to the bracket, and the second end includes an arcuate slot that receive the one or more arcuate struts such that the one or more arms are repositionable in relation to the one or more anchors.

In certain embodiments, the transmission may include one or more torsion gears that engage the one or more anchors and one or more transfer gears that engage the one or more torsion gears.

In certain embodiments, the one or more torsion gears may extend into the one or more anchors.

In certain embodiments, the motor assembly may include a drive shaft that engages one of the one or more transfer gears.

### BRIEF DESCRIPTION OF THE DRAWINGS

The present disclosure is best understood from the following detailed description when read in conjunction with the accompanying drawings. According to common practice, certain components, elements, and/or features may be omitted from certain drawings in the interest of clarity.

FIGS. 1 and 2 are opposite, perspective views of an electronic device in accordance with the principles of the present disclosure, which is shown in an unfolded configuration.

FIG. 3 is a perspective view of the electronic device shown during folding.

FIG. 4 is a perspective view of the electronic device shown in a folded configuration.

FIG. 5 is a perspective view of a dual-axis drive assembly that is configured for use with the electronic device to facilitate reconfiguration of the electronic device between the unfolded and folded configurations.

FIG. 6 is a perspective view of the drive assembly shown during folding of the electronic device.

FIG. 7 is a partial, perspective view of the drive assembly shown with parts separated.

FIG. 8 is a partial, perspective view of the drive assembly, which includes: a chassis; a support assembly; anchors; an (electric) motor assembly; a transmission; and a synchronizing rod.

FIG. 9 is a cross-sectional view taken along line 9-9 in FIG. 5 and illustrating the drive assembly prior to folding of the electronic device.

FIG. 10 is a cross-sectional view taken along line 9-9 in FIG. 5 and illustrating the drive assembly during folding of the electronic device.

FIG. 11 is a cross-sectional view taken along line 11-11 in FIG. 5 and illustrating the drive assembly upon folding of the electronic device.

FIG. 12 is a perspective view of a bracket included in the support assembly.

FIG. 13 is a perspective view of an arm included in the support assembly.

FIG. 14 is a perspective view of one of the anchors.

FIG. 15 is a perspective view of the drive assembly according to one embodiment of the present disclosure and shown upon folding of the electronic device.

FIG. 16 is a perspective view of the motor assembly.

FIG. 17 is a plan view of the motor assembly.

FIG. 18 is a perspective view of a torsion gear included in the transmission.

FIG. 19 is a perspective view of a transfer gear included in the transmission.

FIG. 20 is a plan view of the synchronizing rod.

FIG. 21 is a perspective view of an alternate embodiment of the drive assembly, which includes a pair of motor assemblies that are positioned (located) in side-by-side relation.

FIG. 22 is a perspective view of an alternate embodiment of the drive assembly, which includes a pair of motor assemblies that are positioned (located) in back-to-back relation.

FIG. 23 is a perspective view of the motor assemblies seen in FIG. 22.

### DETAILED DESCRIPTION

The present disclosure describes a reconfigurable, e.g., foldable, electronic device that includes a housing and a dual-axis drive assembly, which is connected to the housing and is configured to facilitate reconfiguration of the electronic device between unfolded and folded configurations. The drive assembly includes, among other components: an (electric) motor assembly; a transmission with first and second transmission assemblies; and a synchronizing rod, which extends between and operatively, e.g., indirectly, connects the transmission assemblies to facilitate power transfer therebetween. The transmission assemblies are operatively, e.g., indirectly, connected to the housing such that torque is applied to the housing via the transmission assemblies to thereby reconfigure, e.g., fold, the electronic device.

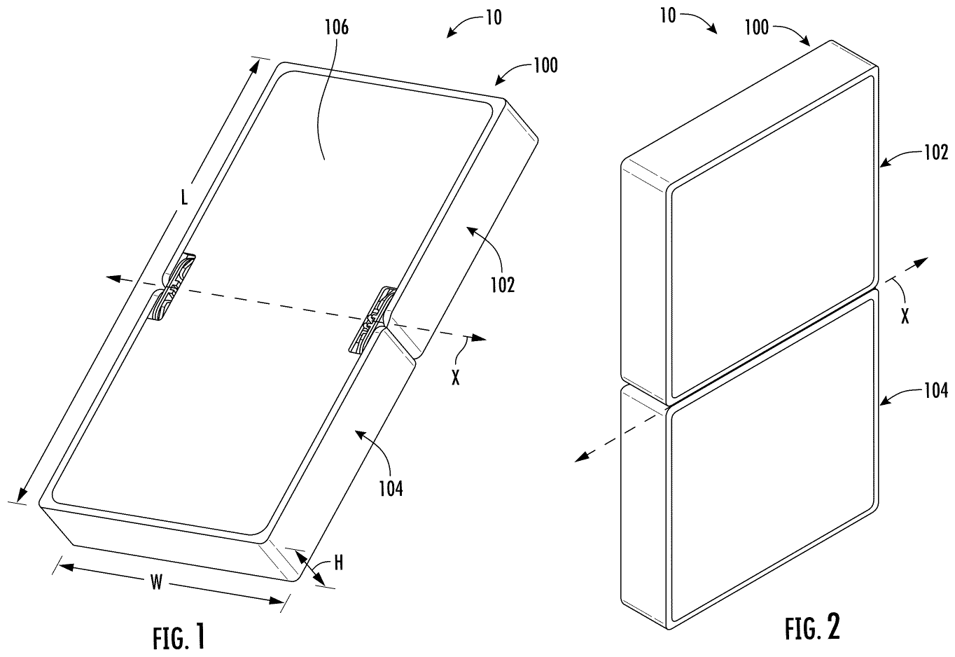

With reference now to the drawings, FIGS. 1-4, a reconfigurable electronic device 10 according to the principles of the present disclosure is illustrated. As described in further detail below, the electronic device 10 is foldable about a folding axis X such that the electronic device is reconfigurable between an unfolded configuration (FIGS. 1, 2) and a folded configuration (FIG. 4).

The electronic device 10 is a foldable image capture device. More specifically, in the illustrated embodiment, the electronic device 10 is configured for releasable connection to a portable biological (health) sensing (detection) device that measures various external environmental parameters in the vicinity of the user and provides the user with health and/or environmental data, e.g., information concerning the user's day-to-day health, sleep quality, etc., based upon the measured parameters in real-time. It is envisioned, however, that the specific configuration and functionality of the electronic device 10 may be varied in alternate embodiments, however. For example, it is envisioned that the electronic device 10 may be configured as a mobile phone, a tablet, a watch, a smart device, etc.

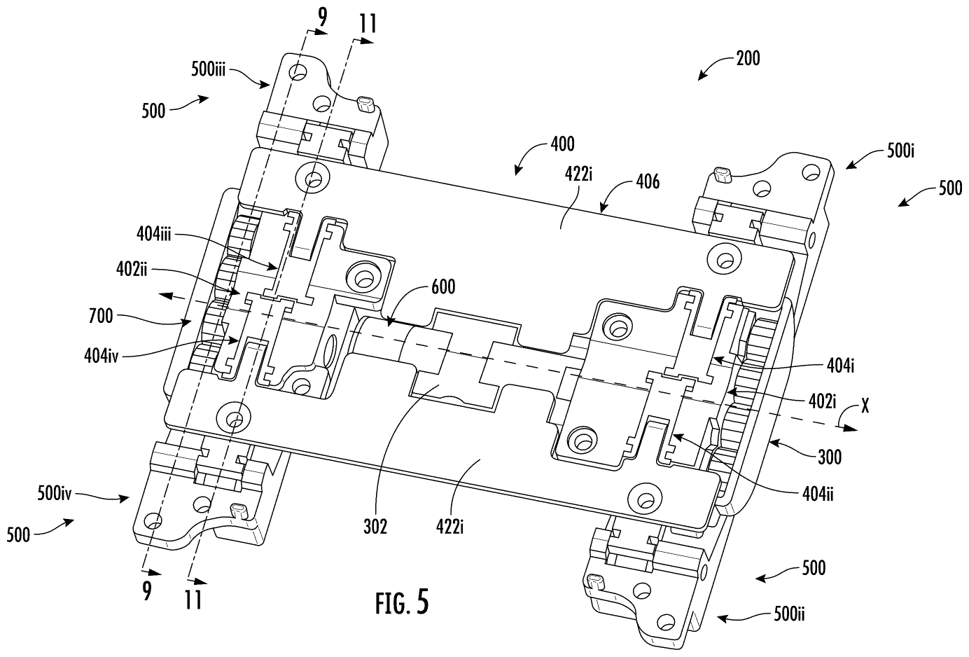

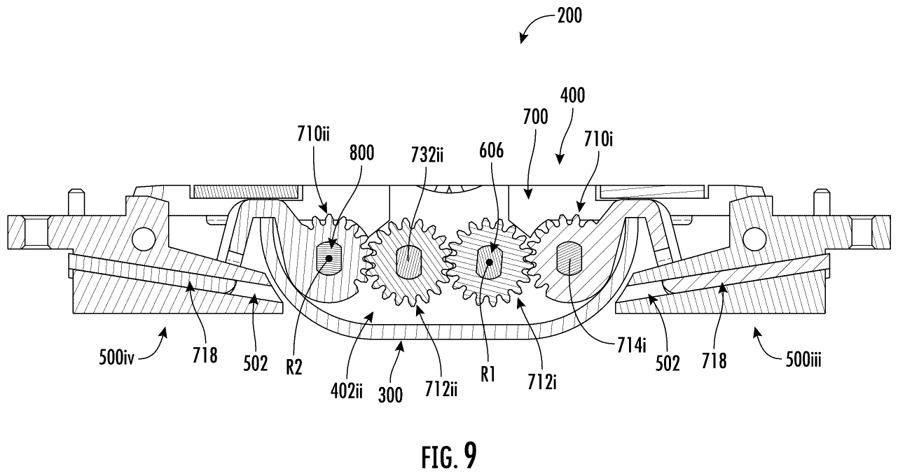

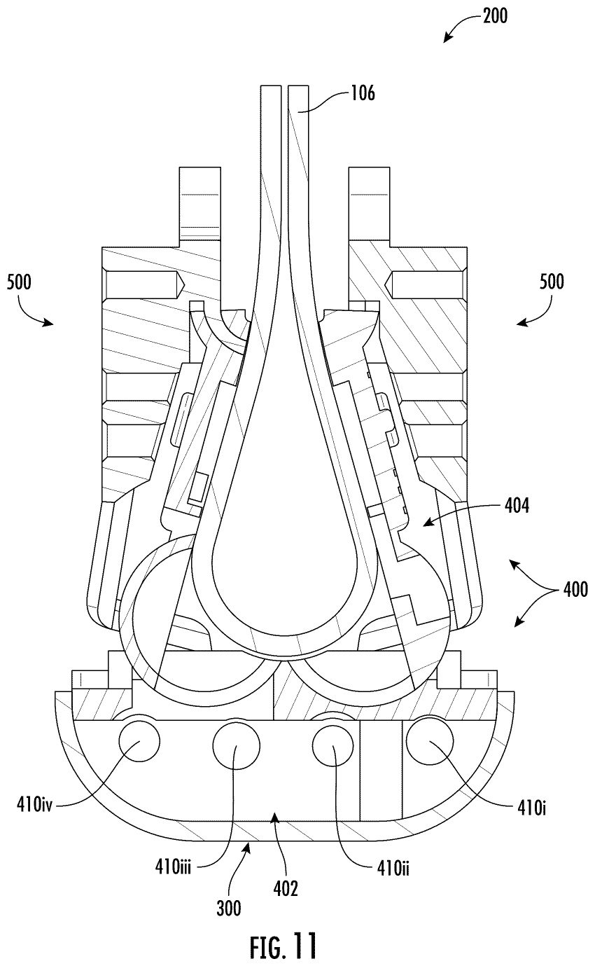

With reference now to FIGS. 5-11 as well, the electronic device 10 defines a total (overall) length L (FIG. 1), a total (overall) width W, and a total (overall) height H and a includes a housing 100 and a dual-axis drive assembly 200.

The housing 100 includes a housing portion 102 (referred to as a first housing portion), which is repositionable (movable) about an axis of rotation R1 (referred to as a first axis of rotation) (FIGS. 8-10); a housing portion 104 (referred to as a second housing portion) that is repositionable (movable) in relation to the housing portion 102 about an axis of rotation R2 (referred to as a second axis of rotation); and a flexible display panel (screen) 106 that is supported by the housing portions 102, 104.

The housing portions 102, 104 are movably connected such that the electronic device 10 is reconfigurable, e.g., foldable, about the folding axis X between the unfolded and folded configurations, which may be accomplished in any suitable manner. For example, it is envisioned that the housing portions 102, 104 may be configured as discrete components that are connected by a mechanical hinge (or other such member) or, alternatively, that the housing portions 102, 104 may be integrally (unitarily, monolithically) formed, e.g., from a single piece of material, and connected by a living hinge.

The drive assembly 200 is connected (secured) to the housing 100 and is configured to facilitate reconfiguration of the electronic device 10 between the unfolded and folded configurations. The drive assembly 200 defines the axes of rotation R1, R2 (FIGS. 8-10) and includes: a chassis 300; a support assembly 400; anchors 500; an (electric) motor assembly 600; a transmission 700; and a synchronizing rod 800.

The drive assembly 200 is configured to act upon each of the housing portions 102, 104, as described in further detail below, such that, during operation of the drive assembly 200, the housing portions 102, 104 articulate in concert (unison, simultaneously) during folding and unfolding of the electronic device 10. Embodiments in which the drive assembly 200 may be configured to act upon one of the housing portions 102, 104 are also envisioned herein, however. In such embodiments, it is envisioned that one of the housing portions 102, 104 may remain stationary while the other of the housing portions 102, 104 is movable through an angular range of motion of approximately 180°.

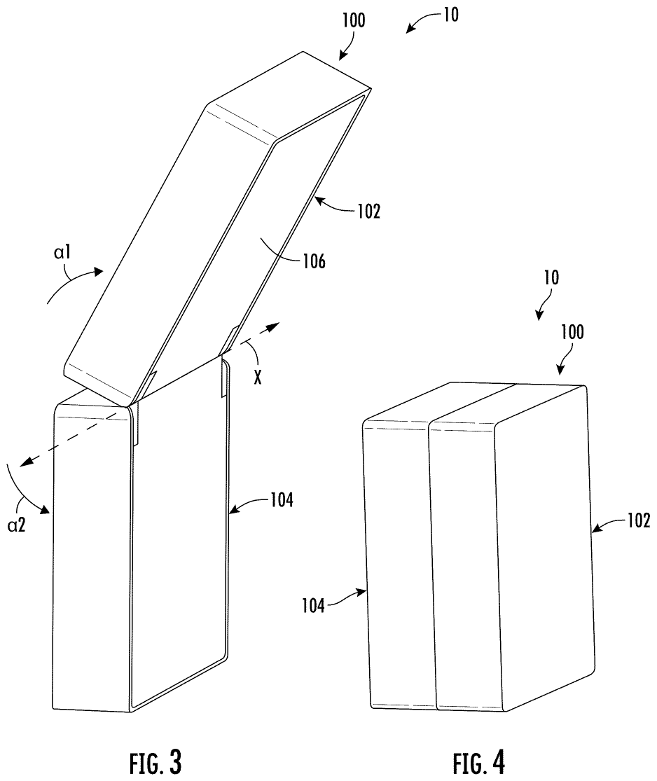

In the illustrated embodiment, the drive assembly 200 is configured such that the housing portions 102, 104 are articulable (movable) through generally equivalent angular ranges of motion α1, α2 (FIG. 3), respectively, that are approximately equal to 90°, which reduces the load on the motor assembly 600 and the transmission 700, thus improving the efficiency thereof. As such, in the folded configuration, the housing portions 102, 104 are superimposed and are oriented in generally parallel relation, as seen in FIG. 4. Embodiments in which the angular ranges of motion α1, α2 may be inequivalent are also envisioned herein, however. For example, embodiments in which the angular ranges of motion α1, α2 may be approximately equal to 45° and 135°, respectively, are also envisioned herein, as are embodiments in which the housing portions 102, 104 may be oriented in non-parallel relation, e.g., at an angle that is approximately equal to 90°, when the electronic device 10 is in the folded configuration.

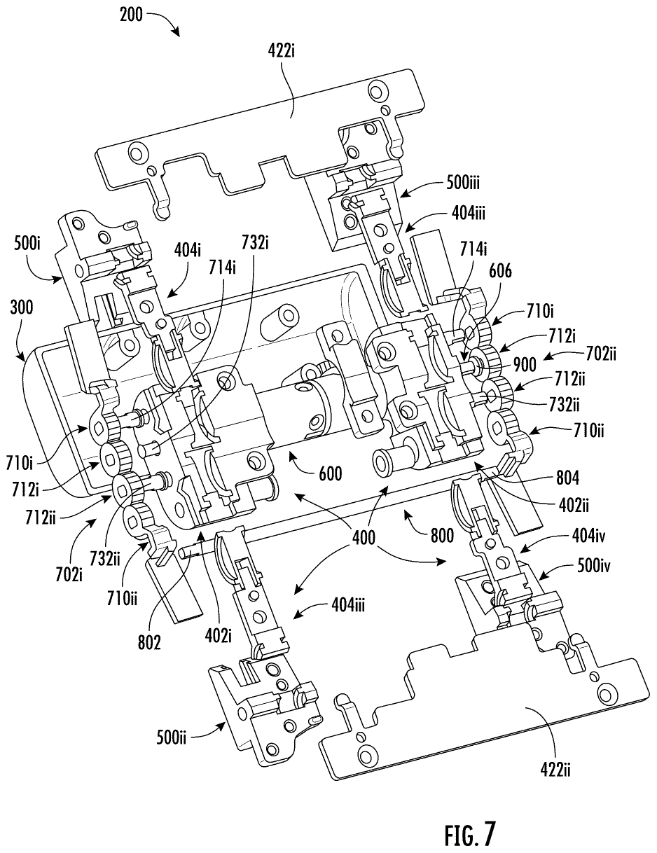

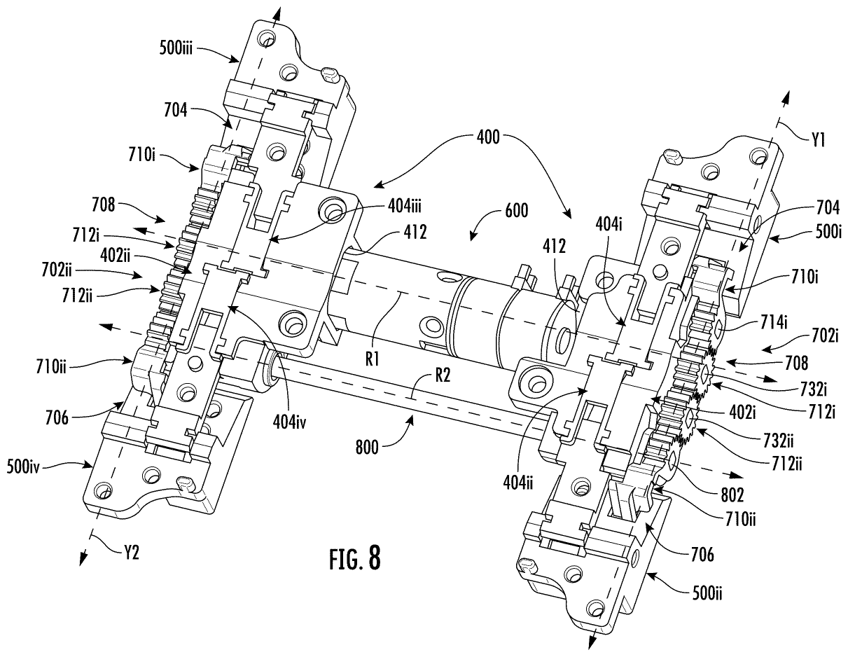

In order to identify the angular positions of the housing portion 102 and/or the housing portion 104, it is envisioned that the drive assembly 200 may include a Hall sensor 900 (FIG. 7), which measures the angular position of the housing portion 102 and/or the angular position of the housing portion 104 via the generation of a magnetic field.

In addition to improving the aesthetic appearance of the drive assembly 200, the chassis 300 receives, shields, and protects the support assembly 400, the motor assembly 600, the transmission 700, the synchronizing rod 800, and the Hall sensor 900. It is envisioned that the chassis 300 may include any suitable material(s) of construction, both metallic and non-metallic.

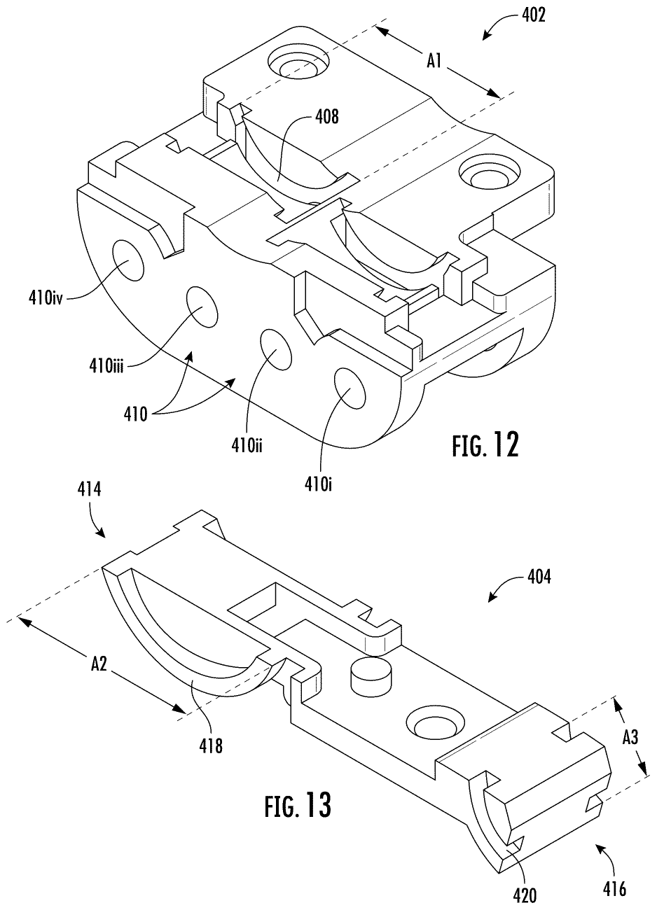

Referring now to FIGS. 12 and 13 as well, the support assembly 400 is connected (secured) to the chassis 300 and the anchors 500 and includes: brackets 402; arms 404; a platform 406. As described in further detail below, the support assembly 400 interfaces with and braces (stabilizes, reinforces, supports) the motor assembly 600, the transmission 700, and the synchronizing rod 800 and indirectly connects the chassis 300 to the anchors 500, the motor assembly 600, the transmission 700, and the synchronizing rod 800.

The brackets 402 are connected (secured) to the chassis 300, e.g., via mechanical fasteners, an adhesive, etc., and span, e.g., extend across (are positioned on opposite sides of), the folding axis X (FIGS. 1-3, 5). More specifically, the support assembly 400 includes a bracket 402i (referred to as a first bracket portion) and a bracket 402 ii (referred to as a second bracket), each of which includes (defines): grooves 408 (FIG. 12); apertures 410; and a seat 412 (FIG. 8).

The grooves 408 (FIG. 12) are arcuate in configuration and receive the arms 404. The grooves 408 allow for relative angular (rotational, pivotable) movement between the brackets 402 and the arms 404 during folding and unfolding of the electronic device 10, as described in further detail below. More specifically, the grooves 408 are configured so as to define arc lengths A1 that are approximately equal to 180°.

The apertures 410 receive the motor assembly 600, the transmission 700, and the synchronizing rod 800 such that the motor assembly 600, the transmission 700, and the synchronizing rod 800 extend through the brackets 402 in generally parallel relation to the folding axis X (FIGS. 1-3, 5) and the axes of rotation R1, R2 (FIGS. 8-10). More specifically, the brackets 402 include (define): an aperture 410i (referred to as a first aperture); an aperture 410ii (referred to as a second aperture); an aperture 410iii (referred to as a third aperture); and an aperture 410iv (referred to as a fourth aperture).

The seats 412 (FIG. 8) extend laterally into the brackets 402 in generally parallel relation to the folding axis X (FIGS. 1-3, 5) and the axes of rotation R1, R2. The seats 412 are configured to receive (interface with) the motor assembly 600 such that the motor assembly 600 extends into the brackets 402, which inhibits (if not entirely prevents) unintended, e.g., off-axis (eccentric) movement, e.g., roll, of the motor assembly 600 during operation of the drive assembly 200 and reconfiguration of the electronic device 10.

The arms 404 engage (contact, interface with) and extend between the brackets 402 and the anchors 500 such that arms 404 indirectly connect (secure) the anchors 500 to the brackets 402. More specifically, the support assembly 400 includes: an arm 404i (referred to as a first arm); an arm 404ii (referred to as a second arm); an arm 404iii (referred to as a third arm); and an arm 404iv (referred to as a fourth arm), each of which includes an end 414 (referred to as a first end) (FIG. 13), which engages (contacts, interfaces with) the brackets 402, and an end 416 (referred to as a second end), which engages (contacts, interfaces with) the anchors 500.

As seen in FIG. 13, the ends 414 of the arms 404 include ribs 418, and the ends 416 of the arms include (define) slots 420.

The ribs 418 are configured in correspondence with and for insertion into (reception by) the grooves 408 in the brackets 402, e.g., such that the configurations of the ribs 418 mirror (match) those of the grooves 408, which facilitates repositioning (movement, articulation) of the arms 404 in relation to the brackets 402 via movement of the ribs 418 through (within) the grooves 408 during folding and unfolding of the electronic device 10. More specifically, the ribs 418 are arcuate in configuration and define arc lengths A2 that are approximately equal to 180°, which allows for mating engagement of (contact between) the arms 404 and the brackets 402.

The arcuate configurations of the grooves 408 and the ribs 418 not only facilitate angular (rotational, pivotable) movement (articulation) between the arms 404 and the brackets 402, but inhibit (if not entirely prevent) the axial, e.g., non-rotational, transfer of force thereto, thereby confining the arms 404 to rotational motion.

The slots 420 are configured to receive (interface with) the anchors 500, which allows for relative angular (rotational, pivotable) movement between the arms 404 and the anchors 500 during folding and unfolding of the electronic device 10, as described in further detail below. The slots 420 are arcuate in configuration and define arc lengths A3, which are less than the arc lengths A2 defined by the ribs 418. More specifically, in the illustrated embodiment, the slots 420 are configured such that the arc lengths A3 are approximately equal to 90°.

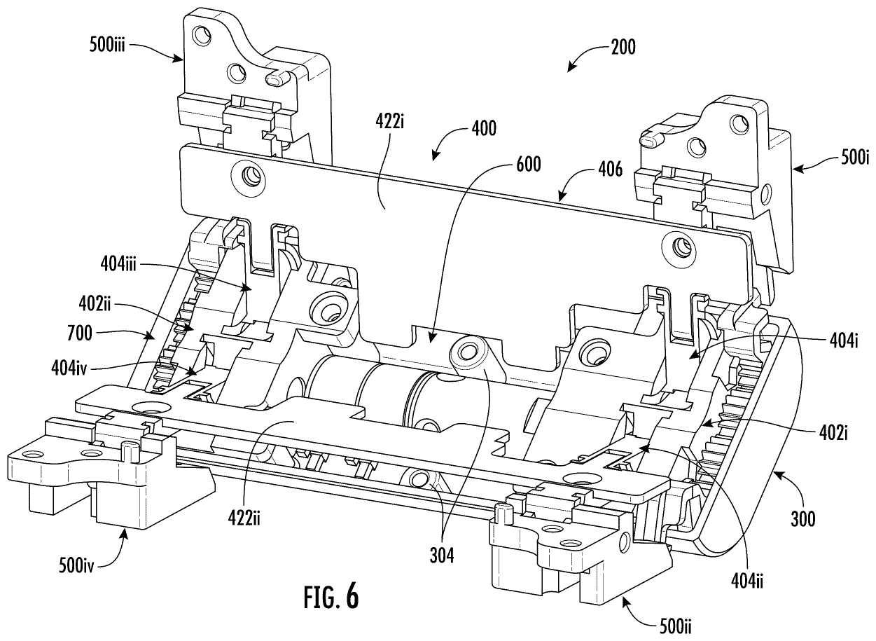

The platform 406 (FIGS. 5, 6) is connected (secured) to the arms 404, e.g., via mechanical fasteners, an adhesive, etc., such that the platform 406 spans, e.g., extends across, the folding axis X (FIGS. 1-3, 5). The platform 406 supports the housing portions 102, 104 (FIGS. 1-4) and, thus, the display panel 106 (FIGS. 1, 3), and facilitates simultaneous articulation of the anchors 500 and the housing portions 102, 104 during folding and unfolding of the electronic device 10, thereby increasing the strength (stability, rigidity) of the drive assembly 200 and the electronic device 10. More specifically, the platform 406 includes a segment 422i (referred to as a first segment), which is connected (secured) to the arms 404i and supports the housing portion 102, and a segment 422ii (referred to as a second segment), which is connected (secured) to the arms 404ii, 404iv and supports the housing portion 104.

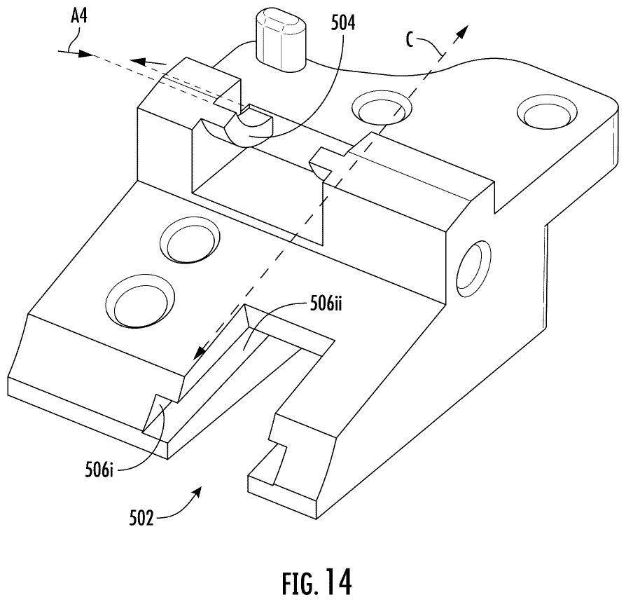

Referring now to FIG. 14 as well, the anchors 500 are directly connected (secured) to the housing portions 102, 104 (FIGS. 1-4), e.g., via mechanical fasteners, an adhesive, etc., the support assembly 400, e.g., the arms 404, and the transmission 700 and are indirectly connected (secured) to the chassis 300 via the support assembly 400, which extends therebetween so as to operatively, e.g., indirectly, connect the housing 100 to the transmission 700. More specifically, the drive assembly 200 includes: an anchor 500i (referred to as a first anchor), which is connected (secured) to the housing portion 102 and engages (contacts, interfaces with) the arm 404i; an anchor 500ii (referred to as a second anchor), which is connected (secured) to the housing portion 104 and engages (contacts, interfaces with) the arm 404ii; an anchor 500iii (referred to as a third anchor), which is connected (secured) to the housing portion 102 and engages (contacts, interfaces with) the arm 404iii; an anchor 500iv (referred to as a fourth anchor), which is connected (secured) to the housing portion 104 and engages (contacts, interfaces with) the arm 404iv, wherein each of the anchors 500i-500iv is positioned (located, housed) internally within the housing 100. The drive assembly 200 is thus configured such that the anchors 500i, 500ii and the anchors 500iii, 500iv span, e.g., extend across (are positioned on opposite sides of), the folding axis X (FIGS. 1-3, 5).

As seen in FIG. 14, the anchors 500 define channels 502 and struts 504.

The channels 502 are generally linear, e.g., non-arcuate, in configuration and are configured to receive (interface with) the transmission 700, which allows for relative angular (rotational, pivotable) movement between the arms 404 and the transmission 700 during folding and unfolding of the electronic device 10, as described in further detail below. More specifically, the channels 502 include (define) channel portions 506i (referred to as a first channel portions), which extend laterally into the anchors 500 in generally parallel relation to the folding axis X (FIGS. 1-3, 5) and the axes of rotation R1, R2 (FIGS. 8-10), and channel portions 506ii (referred to as a second channel portions), which extend into the anchors 500 in generally orthogonal (perpendicular) relation to the channel portions 506i, the folding axis X, and the axes of rotation R1, R2, which attributes a generally T-shaped cross-sectional configuration to the channels 502.

As seen in FIG. 14, in the illustrated embodiment, the channels 502 are eccentrically positioned (located) such that the channels 502 are off-center. More specifically, the anchors 500 are configured such that the channels 502 are spaced non-equidistant from centerlines C thereof.

The struts 504 are configured in correspondence with and for insertion into (reception by) the slots 420 (FIG. 13) on the arms 404, e.g., such that the configurations of the struts 504 mirror (match) those of the slots 420, which facilitates repositioning (movement, articulation) of the arms 404 in relation to the anchors 500 via movement of the struts 504 through (within) the slots 420 during folding and unfolding of the electronic device 10. More specifically, the struts 504 are arcuate in configuration and define arc lengths A4 that are generally identical to the arc lengths A3, e.g., such that the arc lengths A4 are approximately equal to 90°, which allows for mating engagement of (contact between) the arms 404 and the anchors 500.

The arcuate configurations of the slots 420 and the struts 504 not only facilitate angular (rotational, pivotable) movement between the arms 404 and the anchors 500, but inhibit (if not entirely prevent) the axial, e.g., non-rotational, transfer of force thereto. The arcuate configurations of the slots 420 and the struts 504 thus generally confine the arms 404 and the anchors 500 to rotational motion.

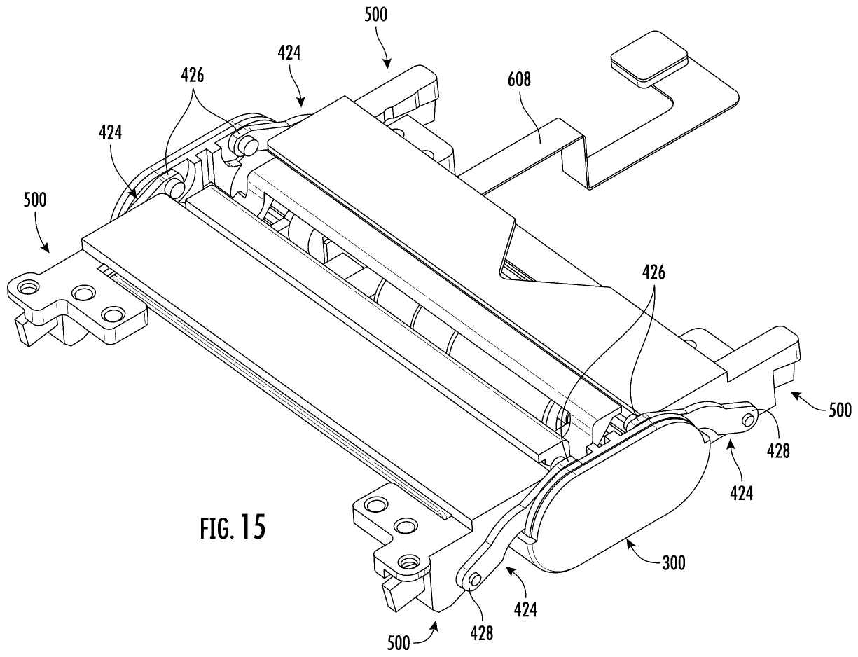

With reference to FIG. 15, in one embodiment of the present disclosure, the support assembly 400 further includes connecting rods 424. Embodiments of the support assembly 400 that are devoid of the connecting rods 424 are also envisioned herein, however.

The connecting rods 424 further increases the strength (stability, rigidity) of the drive assembly 200 and the electronic device 10 and extend between and connect the chassis 300 and the anchors 500. More specifically, the connecting rods 424 include end 426 (referred to as first ends), which are movable (rotationally, pivotably) connected (secured) to the chassis 300, and ends 428 (referred to as a second ends), which are movable (rotationally, pivotably) connected (secured) to the anchors 500. Connecting the anchors 500 to the chassis 300 inhibits (if not entirely prevents) unintended movement, e.g., rattle, of the anchors 500 during operation of the drive assembly 200 and reconfiguration of the electronic device 10.

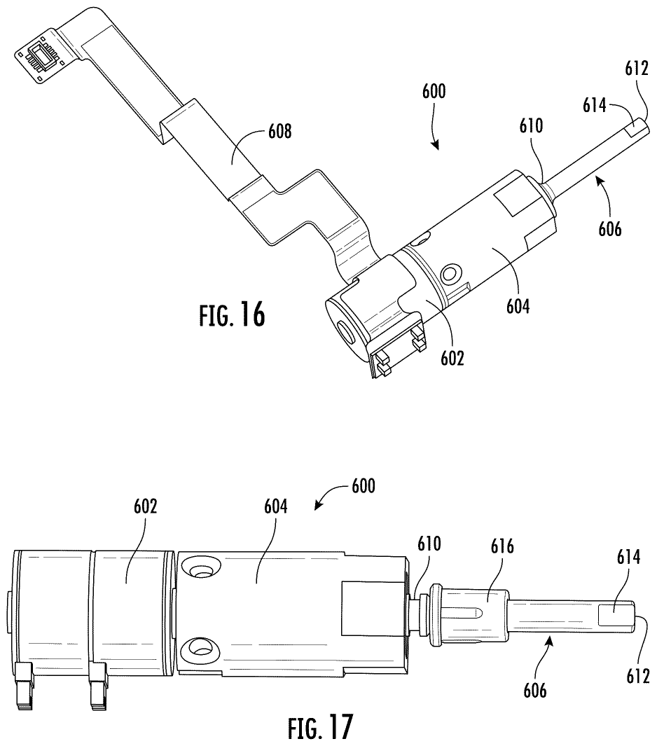

Referring now to FIGS. 16 and 17 as well, the motor assembly 600 is directly connected to the transmission 700, as described in further detail below, such that power from the motor assembly 600 is delivered to the housing 100 via the transmission 700 to thereby fold and unfold the housing 100 during reconfiguration of the electronic device 10. The motor assembly 600 includes: (one or more) at least one (electric) motor 602, which extends into the brackets 402, e.g., the seats 412, as indicated above; (one or more) at least one gearbox 604, which engages (contacts, interfaces with) and is connected (secured) to the motor(s) 602 in order to provide torque amplification; (one or more) at least one drive shaft 606; and a flexible printed circuit (FPC) 608.

In the illustrated embodiment, the motor assembly 600 includes a single motor 602, a single gearbox 604, and a single drive shaft 606. Embodiments in which the motor assembly 600 may include multiple motors 602, gearboxes 604, and drive shafts 606 are also envisioned, however, as described in further detail below.

The motor assembly 600 is connected (secured) to the chassis 300 in order to further inhibit (if not entirely prevent) unintended, e.g., off-axis (eccentric) movement, e.g., roll, of the motor assembly 600 during operation of the drive assembly 200 and reconfiguration of the electronic device 10. More specifically, in the illustrated embodiment, the motor assembly 600 is connected (secured) to the chassis 300 via a retainer 302. As seen in FIGS. 5 and 6, the retainer 302 extends about and receives the motor assembly 600 to fix the position thereof and is secured to bosses 304 on the chassis 300, e.g., via mechanical fasteners, an adhesive, etc.

The drive shaft 606 engages (contacts) and extends between the gearbox 604 and the transmission 700 in order to operatively, e.g., indirectly, connect the motor 602 and the gearbox 604 to the transmission 700 such that the drive shaft 606 transfers (transmits) power and torque from the motor 602, through the gearbox 604, to the transmission 700. The drive shaft 606 defines the axis of rotation R1 and, in the illustrated embodiment, is generally aligned with the Hall sensor 900 (FIG. X), e.g., such that the drive shaft 606 and the Hall sensor 900 are arranged in coaxial relation.

The drive shaft 606 includes an end 610 (referred to as a first end), which engages (contacts, interfaces with) the gearbox 604, and an end 612 (referred to as a second end), which engages (contacts, interfaces with) the transmission 700. The end 612 of the drive shaft 606 includes a non-circular cross-sectional configuration that defines (one or more) at least one flat surface 614, which facilitates engagement (contact) with the transmission 700 and inhibits (if not entirely prevents) relative rotation between the drive shaft 606 and the transmission 700.

In order to reduce friction during rotation, the drive shaft 606 includes (one or more) at least one bushing 616, which extends about and receives the drive shaft 606.

The FPC 608 extends between and electrically connects the electronic device 10 and the motor assembly 600 in order to facilitate the communication of data and/or power therebetween. For example, the FPC 608 facilitates the transmission of activation and deactivation signals to the motor assembly 600 in order to initiate and terminate reconfiguration (folding) of the electronic device 10.

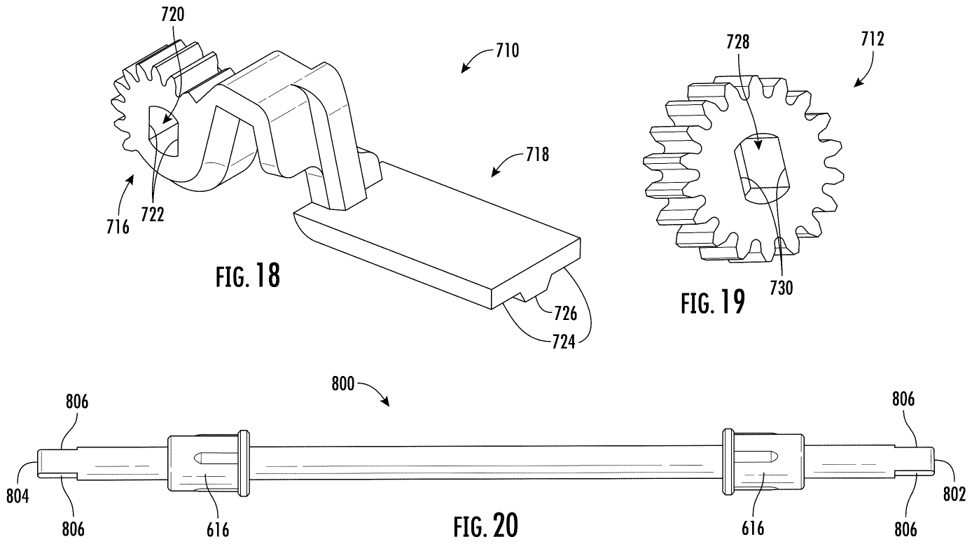

Referring now to FIGS. 18 and 19 as well, the transmission 700 includes (first, second) transmission assemblies 702i, 702ii (FIGS. 7, 8) and directly engages (contacts, interfaces with) and extends between the anchors 500 and the motor assembly 600 in order to transfer (transmit) power and torque from the motor assembly 600 to the anchors 500 to facilitate repositioning (movement, articulation) of the anchors 500 and, thus, reconfiguration of the electronic device 10 between the folded and unfolded configurations. The transmission assemblies 702i, 702ii are spaced apart (separated) along and span, e.g., extend across (are positioned on opposite sides of), the folding axis X (FIGS. 1-3, 5) such that the transmission assemblies 702i, 702ii extend in generally orthogonal (perpendicular) relation to the folding axis X and the axes of rotation R1, R2 (FIGS. 8-10), which extend between and pass through each of the transmission assemblies 702i, 702ii.

The transmission assemblies 702i, 702ii each include ends 704 (referred to as first ends) (FIG. 8), which engage the anchors 500i, 500iii and are thus indirectly connected (secured) to the housing portion 102 (FIGS. 1-4), and ends 706 (referred to as second ends), which engage the anchors 500ii, 500iv and are thus indirectly connected (secured) to the housing portion 104. More specifically, the transmission assemblies 702i, 702ii are configured such that the ends 704, 706 of the transmission assembly 702i are spaced apart (separated) along an axis Y1 (referred to as a first axis), and such that the ends 704, 706 of the transmission assembly 702ii are spaced apart (separated) along an axis Y2 (referred to as a second axis), wherein the axes Y1, Y2 extend in generally parallel relation to each other and in generally orthogonal (perpendicular) relation to the folding axis X (FIGS. 1-3, 5) and the axes of rotation R1, R2 (FIGS. 8-10).

The transmission assemblies 702i, 702ii each include a plurality of gears 708, which are oriented in generally linear arrangements along the axes Y1, Y2, respectively. More specifically, the transmission assemblies 702i, 702ii each include (first, second) torsion gears 710i, 710ii and (one or more) at least one transfer gear 712, which is positioned (located) between the torsion gears 710i, 710ii.

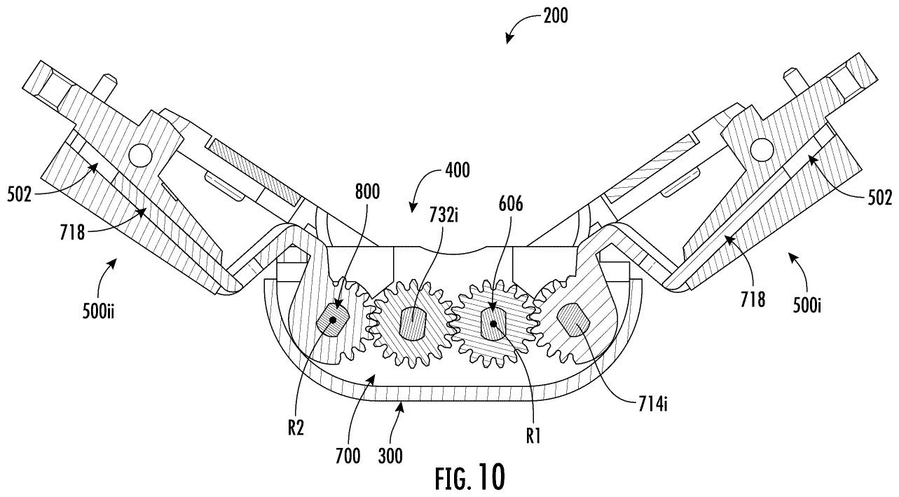

The torsion gears 710i, 710ii are supported by the brackets 402 such that the torsion gears 710i, 710ii are rotatable in relation thereto. More specifically, the torsion gears 710i are connected (secured) to the brackets 402 by pins 714i (FIGS. 8-10), which extend into and through the apertures 410i (FIGS. 10, 12) in the brackets 402, and the torsion gears 710ii engage (contact, interface with) the synchronizing rod 800, which extends into and through the apertures 410iv in the brackets 402.

The torsion gears 710i, 710ii directly engage (contact) the anchors 500 such that movement (articulation, rotation, pivoting) of the torsion gears 710i, 710ii causes corresponding movement (articulation, rotation, pivoting) of the anchors 500. More specifically, the torsion gears 710i, 710ii in the transmission assembly 702i respectively engage (contact) the anchors 500i, 500ii, and the torsion gears 710i, 710ii in the transmission assembly 702ii respectively engage (contact) the anchors 500iii, 500iv.

As seen in FIG. 18, each of the torsion gears 710i, 710ii includes a gear portion 716 and a torque arm (torsion bar) 718, which extends from the gear portion 716 in generally orthogonal (perpendicular) relation to the folding axis X (FIGS. 1-3, 5) and the axes of rotation R1, R2 (FIGS. 8-10) when the electronic device 10 is in the unfolded configuration.

Each of the gear portions 716 includes an opening 720 with a non-circular cross-sectional configuration that defines (one or more) at least one flat surface 722, which facilitates engagement (contact) with the synchronizing rod 800 and inhibits (if not entirely prevents) relative rotation therebetween, as described in further detail below.

In the illustrated embodiment, the torsion gears 710i, 710ii are integrally (unitarily, monolithically) formed, e.g., such that the gear portions 716 and the torque arms 718 are formed from a single piece of material. Embodiments in which the gear portions 716 and the torque arms 718 may be formed as separate, discrete components are also envisioned herein, however.

The torque arms 718 extend into the anchors 500. More specifically, the torque arms 718 are configured in correspondence with and for insertion into (reception by) the channels 502 (FIG. 14) in the anchors 500, e.g., such that the configurations of the torque arms 718 mirror (match) those of the channels 502, which facilitates repositioning (movement) of the torsion gears 710i, 710ii in relation to the anchors 500 via movement, e.g., sliding, of the torque arms 718 through (within) the channels 502 during folding and unfolding of the electronic device 10. As seen in FIG. 18, the torque arms 718 are generally linear, e.g., non-arcuate, in configuration and each include (define) a base 724 and a spine 726.

The bases 724 extend laterally, e.g., in generally parallel relation to the folding axis X (FIGS. 1-3, 5) and the axes of rotation R1, R2 (FIGS. 8-10), and are configured in correspondence with and for insertion into the channel portions 506i (FIG. 14), e.g., such that the configurations of the bases 724 mirror (match) those of the channel portions 506i, whereby, upon insertion of the torque arms 718 into the channels 502, the bases 724 are received by the channel portions 506i.

The spines 726 extend from the bases 724 in generally orthogonal (perpendicular) relation thereto as well as in generally orthogonal (perpendicular) relation to the folding axis X (FIGS. 1-3, 5) and the axes of rotation R1, R2 (FIGS. 8-10), which attributes a generally T-shaped cross-sectional configuration to the torque arms 718. The spines 726 are configured in correspondence with and for insertion into the channel portions 506ii (FIG. 14), e.g., such that the configurations of the spines 726 mirror (match) those of the channel portions 506ii, whereby, upon insertion of the torque arms 718 into the channels 502, the spines 726 are received by the channel portions 506ii.

As seen in FIGS. 8-10, the transfer gear(s) 712 are positioned (located) between the torsion gears 710i, 710ii and are supported by the brackets 402 such that the transfer gear(s) 712 are rotatable in relation thereto in concert (unison, simultaneously). More specifically, the transfer gears 712i, 712ii are positioned (located) in mating (meshing) engagement (contact) with each other and with the torsion gears 710i, 710ii, respectively such that rotation of the transfer gears 712i, 712ii causes corresponding rotation of the torsion gears 710i, 710ii and rotation of the torsion gears 710i, 710ii causes corresponding rotation of the transfer gears 712i, 712ii.

Although the transmission 700 is shown as including a pair of transfer gears 712i, 712ii, embodiments of the transmission assembly 702 that include a single transfer gear 712 are also envisioned herein as are embodiments including three or more transfer gears 712, e.g., depending upon the particular configuration of the electronic device 10, the size and scale of the drive assembly 200, etc.

As seen in FIG. 19, each of the transfer gears 712 includes an opening 728 with a non-circular cross-sectional configuration that defines (one or more) at least one flat surface 730, which facilitates engagement (contact) with the drive shaft 606. More specifically, the flat surface(s) 730 are each configured for mating engagement (contact) with the flat surface(s) 614 (FIGS. 16, 17) defined by the end 612 of the drive shaft 606, which inhibits (if not entirely prevents) relative rotation therebetween such that rotation of the drive shaft 606 causes corresponding rotation of the transfer gears 712i, 712ii.

The transfer gears 712i, 712ii in the transmission assemblies 702i, 702ii, although identical, operate differently and perform disparate functions, which is a result of the inclusion of a single motor 602, a single gearbox 604, and a single drive shaft 606. More specifically, in the transmission assembly 702ii, the transfer gear 712i engages (contacts, interfaces with) the drive shaft 606, which extends through the aperture 410 ii in the bracket 402ii and into the opening 728 in the transfer gear 712i, via engagement (contact) between the flat surfaces 614, 630, and the transfer gear 712 ii is connected (secured) to the bracket 402ii by a pin 732 ii (FIGS. 7, 9, 10), which extends into the aperture 410 iii in the bracket 402i. The transmission 700, e.g., the transmission assembly 702ii, is thus directly connected to the motor assembly 600 via the engagement of (contact between) the drive shaft 606 and the transfer gear 712i, whereby the transfer gear 712i in the transmission assembly 702ii receives power and torque directly from the motor assembly 600 and transfers (transmits) that power to the transfer gear 712ii and the torsion gears 710i, 710ii. By contrast, in the transmission assembly 702i, the transfer gears 712i, 712ii are connected (secured) to the bracket 402i by pins 732i, 732ii, which extend into the apertures 410ii, 410iii in the bracket 402i, respectively. The transfer gears 712 i, 712 ii in the transmission assembly 702i thus receive power and torque from the motor assembly 600 indirectly, which is facilitated by the synchronizing rod 800, as described in further detail below, whereby the motor assembly 600 is devoid of any direct connection to the transmission assembly 702i.

With reference now to FIGS. 7-10 and 20, the synchronizing rod 800 will be discussed. The synchronizing rod 800 extends between and operatively, e.g., indirectly, connects the transmission assemblies 702i, 702ii to facilitate power transfer therebetween such that the transmission assemblies 702i, 702ii are operable in concert (unison, simultaneously) to transfer (transmit) power and torque to the anchors 500 concomitantly during folding of the electronic device 10.

The synchronizing rod 800 includes (first, second) ends 802, 804 and defines the axis of rotation R2 which, in the illustrated embodiment, is offset from the axis of rotation R1 along the length L (FIG. 1) of the electronic device 10 (and the axes Y1, Y2 (FIG. 8)).

The synchronizing rod 800 and, thus, the axis of rotation R2, extends in generally parallel relation to the folding axis X (FIGS. 1-3, 5) and the drive shaft 606 and, thus, the axis of rotation R1. More specifically, the ends 802, 804 (FIGS. 7, 8, 20) of the synchronizing rod 800 engage (contact, interface with) the torsion gears 710ii in the transmission assemblies 702i, 702ii, respectively, such that rotation of the torsion gear 710ii in the transmission assembly 702ii, e.g., via engagement (contact) with the transfer gear 712ii, causes corresponding rotation of the torsion gear 710ii in the transmission assembly 702i and, thus, the torsion gear 710i and the transfer gears 712i, 712ii.

The ends 802, 804 of the synchronizing rod 800 include non-circular cross-sectional configurations that each define (one or more) at least one flat surface 806, which facilitates engagement (contact) with the torsion gears 710ii. More specifically, the flat surface(s) 806 are each configured for mating engagement (contact) with the flat surface(s) 722 (FIG. 18) defined by the openings 720 in the torsion gears 710ii. Engagement (contact) between the flat surfaces 722, 806 inhibits (if not entirely prevents) relative rotation between the torsion gears 710ii and the synchronizing rod 800 such that rotation of the torsion gear 710ii in the transmission assembly 702ii causes corresponding rotation of the synchronizing rod 800, which results in corresponding rotation of the torsion gear 710ii in the transmission assembly 702i.

In order to reduce friction during rotation, the synchronizing rod 800 includes (one or more) at least one of the bushings 616, which extends about and receives the synchronizing rod 800.

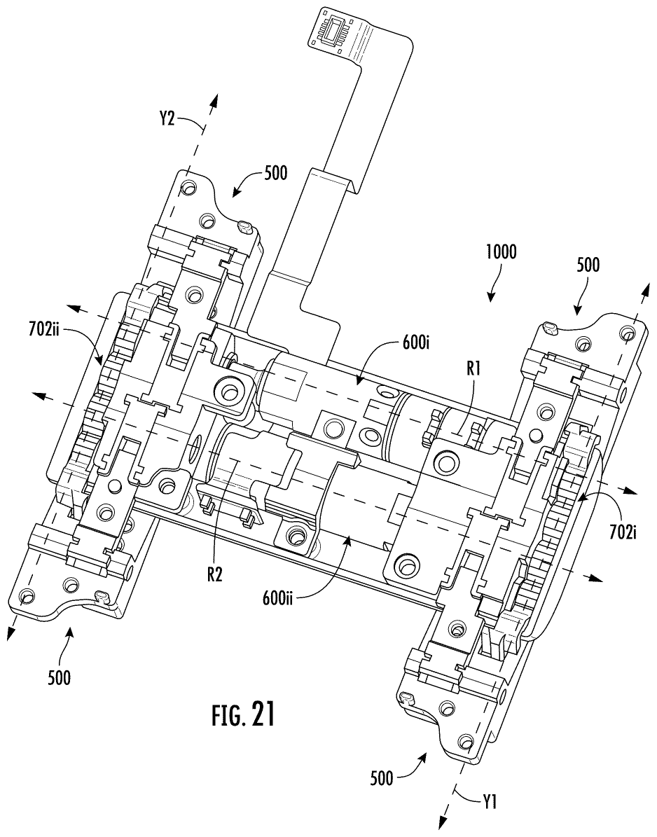

With reference now to FIG. 21, an alternate embodiment of the drive assembly 200 will be discussed, which is identified by the reference character 1000. The drive assemblies 200, 1000 are substantially similar in both structure and operation and, accordingly, will only be described with respect to certain differences therefrom in the interest of brevity. As such, identical reference characters will be utilized to identify components common to the drive assemblies 200, 1000.

In contrast to the drive assembly 200 discussed above, the drive assembly 1000 includes a pair of the motor assemblies 600, which not only increases the torque produced by the drive assembly 1000, e.g., in relation to the drive assembly 200, but obviates the need for the synchronizing rod 800 (FIGS. 7-10 and 20). More specifically, the drive assembly 1000 includes a motor assembly 600i (referred to as a first motor assembly), which is directly connected to the transmission assembly 702ii, and a motor assembly 600ii (referred to as a second motor assembly), which is directly connected to the transmission assembly 702i.

The motor assemblies 600i, 600ii are oriented in generally opposite directions and are positioned (located) in side-by-side relation such that the motor assemblies 600i, 600ii are offset along the length L (FIG. 1) of the electronic device 10 (and the axes Y1, Y2). More specifically, the motor assemblies 600i, 600ii and, thus, the axes of rotation R1, R2, extend in generally parallel relation.

During operation of the drive assembly 200, the motor assemblies 600i, 600ii are actuated simultaneously such that the transmission assemblies 702i, 702ii are operable in concert (unison, simultaneously) to transfer (transmit) power and torque to the anchors 500 concomitantly during folding of the electronic device 10, thereby obviating the need for the synchronizing rod 800, as indicated above.

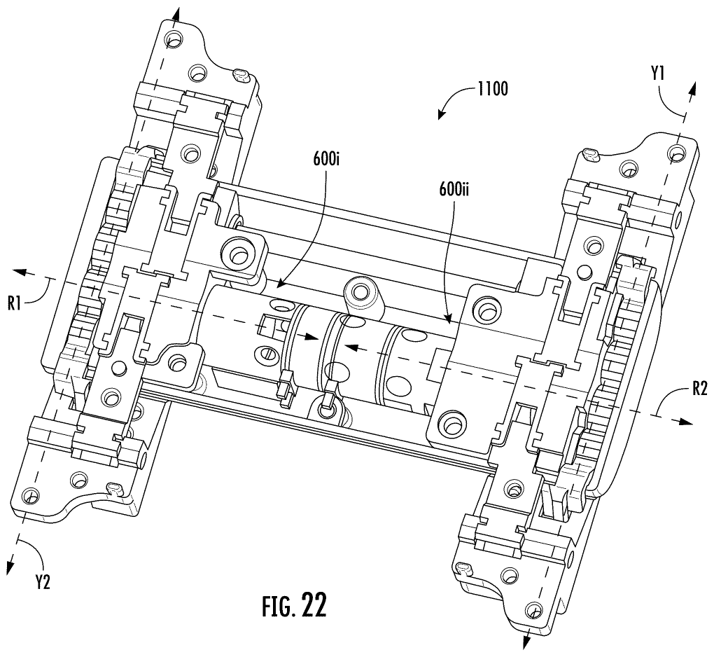

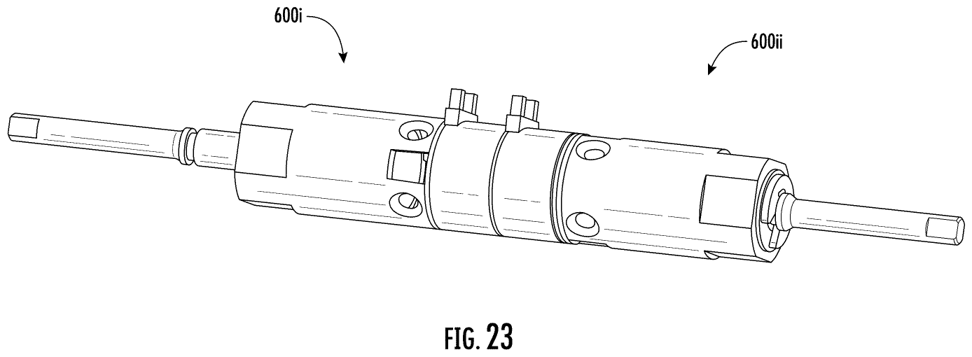

FIGS. 22 and 23 illustrate an alternate embodiment of the drive assembly 1000, which is identified by the reference character 1100. The drive assemblies 1000, 1100 are substantially similar in both structure and operation and, accordingly, will only be described with respect to certain differences therefrom in the interest of brevity. As such, identical reference characters will be utilized to identify components common to the drive assemblies 1000, 1100.

In contrast to the drive assembly 1000 (FIG. 21), in which the motor assemblies 600i, 600ii are oriented in side-by-side relation, in the drive assembly 1100, the motor assemblies 600i, 600ii are oriented in back-to-back relation such that the motor assemblies 600i, 600ii and, thus, the axes of rotation R1, R2 are generally arranged in colinear relation and are generally aligned along the length L (FIG. 1) of the electronic device 10 (and the axes Y1, Y2).

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above but is defined by the claims that follow and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately) 225°) and the term “generally orthogonal” should be understood as referring to configurations in with the pertinent components are oriented so as to define an angle therebetween that is equal to 90°±25% (e.g., an angle that lies within the range of (approximately) 67.5° to (approximately) 112.5°). The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C,” “at least one of A, B, or C”, and “A and/or B and/or C” should each be interpreted to include only A, only B, only C, and any combination of A, B, and C. “At least one of A and B”, “at least one of A or B”, “A and/or B” should each be interpreted to include A only, B only, as well as both A and B.

What is claimed is:

1. An electronic device comprising:
a housing reconfigurable between unfolded and folded configurations about a folding axis; and
a drive assembly connected to the housing and configured to facilitate reconfiguration of the housing between the unfolded and folded configurations, wherein the drive assembly includes:
a transmission connected to the housing, wherein the transmission includes:
a first transmission assembly including a first plurality of gears; and
a second transmission assembly including a second plurality of gears; and
at least one motor assembly connected to the transmission such that power from the at least one motor assembly is delivered to the housing via the transmission, wherein the drive assembly defines a first axis of rotation and a second axis of rotation each extending between the first transmission assembly and the second transmission assembly.

2. The electronic device of claim 1, wherein the first transmission assembly is connected to the second transmission assembly.

3. The electronic device of claim 1, wherein the second transmission assembly is spaced from the first transmission assembly along the folding axis.

4. The electronic device of claim 1, further comprising:
one or more anchors extending between and connecting the housing and the transmission.

5. The electronic device of claim 4, wherein the one or more anchors include:
a first anchor engaging the first transmission assembly and spanning the folding axis; and
a second anchor engaging the second transmission assembly and spanning the folding axis.

6. The electronic device of claim 1, wherein the housing includes:
a first housing portion movable about the first axis of rotation; and
a second housing portion movable in relation to the first housing portion about the second axis of rotation.

7. The electronic device of claim 6, wherein the first transmission assembly and the second transmission assembly each include:
a first end connected to the first housing portion; and
a second end connected to the second housing portion.

8. The electronic device of claim 7, wherein the first end of the first transmission assembly is spaced from the second end of the first transmission assembly along a first axis, and the first end of the second transmission assembly is spaced from the second end of the second transmission assembly along a second axis extending in generally parallel relation to the first axis, wherein the first axis of rotation and the second axis of rotation are each oriented in generally orthogonal relation to the folding axis.

9. The electronic device of claim 1, wherein the first axis of rotation and the second axis of rotation extend between the first transmission assembly and the second transmission assembly.

10. The electronic device of claim 9, wherein the drive assembly is configured such that the first axis of rotation and the second axis of rotation are offset along a length of the electronic device.

11. The electronic device of claim 9, wherein the drive assembly is configured such that the first axis of rotation and the second axis of rotation are generally aligned along a length of the electronic device.

12. The electronic device of claim 1, wherein the at least one motor assembly includes:
at least one motor;
at least one gear box connected to the at least one motor; and
at least one drive shaft connected to the at least one gear box and engaging the transmission.

13. The electronic device of claim 12, further comprising a synchronizing rod connecting the first transmission assembly and the second transmission assembly, wherein the synchronizing rod extends in generally parallel relation to the at least one drive shaft.

14. The electronic device of claim 12, wherein the at least one motor assembly includes a first motor assembly and a second motor assembly.

15. The electronic device of claim 14, wherein the first motor assembly and the second motor assembly are offset along a length of the electronic device.

16. The electronic device of claim 14, wherein the first motor assembly and the second motor assembly are generally aligned along a length of the electronic device.

17. An electronic device comprising:
a housing;
one or more anchors connected to the housing and including one or more arcuate struts;
a support assembly connected to the one or more anchors, wherein the support assembly includes:
a bracket defining an arcuate groove; and
one or more arms engaging the bracket, wherein the one or more arms include:
a first end including an arcuate rib, wherein the arcuate rib is positioned within the arcuate groove such that the one or more arms are repositionable in relation to the bracket; and
a second end including an arcuate slot, wherein the arcuate slot receives the one or more arcuate struts such that the one or more arms are repositionable in relation to the one or more anchors;
a transmission engaging the one or more anchors; and
a motor assembly connected to the transmission, wherein the transmission is configured to transmit power from the motor assembly to the one or more anchors to thereby reconfigure the electronic device between unfolded and folded configurations.

18. The electronic device of claim 17, wherein the transmission includes:
one or more torsion gears engaging the one or more anchors; and
one or more transfer gears engaging the one or more torsion gears.

19. The electronic device of claim 18, wherein the one or more torsion gears extend into the one or more anchors.

20. The electronic device of claim 18, wherein the motor assembly includes a drive shaft engaging one of the one or more transfer gears.
